(19) United States
(12) Patent Application Publication
(10) Pub. No.: US 2006/0027344 A1
(43) Pub. Date: Feb. 9, 2006

(54) Door hanging assembly

(76) Inventors: John K. Lampe, St. Paul, MN (US); Douglas R. Oudekerk, St. Paul, MN (US)

Correspondence Address: John K. Lampe, 262 Griggs St. South, St. Paul, MN, 55105, US

(21) Appl. No.: 11/186,304

(22) Filed: Jul. 21, 2005

Related U.S. Application Data
(60) Provisional application No. 60/591,178, filed on Jul. 26, 2004.
(60) Provisional application No. 60/637,416, filed on Dec. 20, 2004.

(51) Int. Cl. E05D 15/00

(52) U.S. Cl. 160/209

(57) ABSTRACT

A door hanging assembly for hanging on a sectional garage door. The door hanging assembly includes a hung object with a top end and a bottom end and at least one hook configured and arranged for hanging the top end of the hung object on the top edge of the top section of the garage door. The door hanging assembly can further include at least one stabilizer affixed to the bottom end of the hung object to maintain the bottom end of the hung object between the top edge and the bottom edge of one section when the garage door opens and closes.

This application claims the benefit of U.S. Provisional Applications No. 60/591,178 filed on Jul. 26, 2004, and No. 60/637,416 filed on Dec. 20, 2004.

### FIELD OF INVENTION

The present invention generally relates to a decorative or novelty device. Specifically, the device is a door hanging for hanging on doors such as garage doors or doors of homes. The door hanging could display decorative or utilitarian images including graphic, cut-out, or three-dimensionally shaped images.

### BACKGROUND OF INVENTION

Doors present an ideal location for displays of various kinds including decorative ones. This is especially true of garage doors on residential homes. For many homes the garage door offers a large, prominent, substantially flat surface for display.

However, attaching decorations to a garage door presents challenges. Garage doors, when being opened and closed, have moving parts. More specifically, each section of a sectional garage door typically installed at most residences pivots in relation to the other sections when the door is opened and closed. Any decoration on a sectional garage door must somehow accommodate this movement. Otherwise the decoration or, worse, the garage door or garage door frame may be damaged.

Moreover, the exterior surface of garage doors are exposed to the elements. Wind, moisture, cold, heat, and sunshine can all damage decorations and make secure attachment more difficult. Finally, garage door openings, garage doors, and the parts of a garage door may vary in size. Most garage doors have a standard section height of twenty-one inches. However, garage door width (for one or two vehicles) and the height of garage doors can vary more widely. This potential for variation can greatly affect decisions about the sizing and overall design of the decorations intended for garage doors.

The prior art contains numerous examples of garage door displays and displays for other kinds of doors. The prior art includes U.S. Patent App. No 2003/0070335 of Kim (large self-adhesive stickers each covering a section of a garage door); U.S. Pat. No. 6,395,369 to Randone (banner that attaches to top and bottom edges of garage door); U.S. Pat. No. 6,308,474 to Wilson (a cover of resilient material that is creased along at least the top edge to hang from the top edge of a house door); U.S. Pat. Nos. 6,059,005, 6,035,919, 5,946,869, 5,943,803, and 5,937,587 to Zinbarg (all of which attach or have components that attach to a surface of a garage door such as by adhesives or magnets).

The prior art suffers from certain shortcomings or limitations. The purpose of the present invention is to overcome the shortcomings or limitations in the prior art.

### SUMMARY OF INVENTION

The present invention generally relates to a decorative or novelty device. Specifically, the device is a door hanging for hanging on doors such as garage doors or doors of homes. The door hanging could display decorative or utilitarian images including graphic, cut-out, or three-dimensionally shaped images. In at least one embodiment, the door hanging could consist of a hung object such as a flexible sheet, attachment means such as hooks, and stabilizers such as dowels. The top of the hung object could mechanically attach to the top edge of the door with the hooks. The hung object could hang over the exterior surface of the door. The bottom edge of the hung object could hang freely. The stabilizers could be incorporated into the banner near the top and bottom edges to maintain the shape of the hung object and to hold the hung object in place.

In another embodiment, the banner could consist of a flexible sheet, attachment means, and a stabilizer. The top of banner could attach to the top edge of the door with the attachment means. The flexible sheet could hang over the exterior surface of the door. The bottom edge of the banner could hang freely. The stabilizer could be a pipe-shaped member incorporated into the banner near the bottom edge to maintain the shape of the banner and to hold the banner in place.

### OBJECTS AND ADVANTAGES

This invention encompasses embodiments with one or more of the following objects. The advantages and objects of this invention include:

A door banner that is safe for use; that is easy and convenient to use; that can be packaged for easy storage, shipping, and opening by the user; that is easy and economical to manufacture; that does not damage structures from which it is hung or other structures or items near the banner.

A door banner whose functions could include: displaying various images such as decorative ones (e.g., holiday themes) or utilitarian ones (e.g., home-for-sale) on its exterior surface.

A door banner that could be made of various sizes and shapes for different applications.

A door banner that could be made of one or a combination of materials including plastics (both natural or synthetic), foams, metals, cellulose based materials, woven or nonwoven fabrics, glass, or ceramic.

A door banner that attaches to the top portion of a door by attachment means such as a clip that hangs from the top edge of a door or a magnet that mounts to a surface of the garage door.

A door banner with a bottom portion that would not have to be attached to the door.

A door banner whose position on a door and whose shape could be maintained by a stabilizer that could add weight and structure to a banner and that could preferably be located in the bottom portion of the banner.

A door banner with a flexible sheet that could be made of various materials or combinations of materials including woven or nonwoven fabrics; plastics including plastic sheeting or foam; paper or paper-like materials; and synthetic or natural materials.

A door banner with a flexible sheet on which images could be affixed by various methods or combinations of methods including: printing, stamping, or embossing; attaching components of different sizes, shapes, and materials such as shaped fabric components or three-dimensionally-shaped latex rubber components that could be sewn or otherwise attached to the flexible sheet; cutting portions of the flexible sheet to create silhouettes or openings in the flexible sheet; or applying material such as curable foams or latex-like material to create raised portions on the flexible sheet.

A door banner with a flexible sheet that could have a grid of small holes in it, for example, to limit billowing of the flexible sheet in the wind.

A door banner with attachment means of different kinds including ones that use hooks or hooking devices (such as C-shaped hooks that hang from the top of a door), adhesives, magnets, hook and loop, etc.

A door banner with attachment means of different kinds of materials or combinations of materials including: adhesives; magnets; puncturing devices such as nails or tacks; woven or nonwoven fabrics; plastics including foams and molded plastics; fiberglass; metals; and synthetic or natural materials.

A door banner that could include a stabilizer of different kinds, including elongated items such as a section or sections of pipe or bar; blocks or disks of items; or bags of material.

A door banner with a stabilizer that could include different kinds of materials or combinations of materials including metals, plastics, loose materials such as sand or beads, preferably with a greater weight than the banner material and a greater stiffness than the banner material.

Additional Objects Include:

A door hanging that could be suitable for a door such as a garage door such that, for example, the hung object could fit within the door frame and not interfere with the opening and closing of the sections of the garage door.

A door hanging that could comprise at least attachment means such as a hook and a hung object.

A door hanging that could comprise at least a hook, a hung object, and a stabilizer.

A door hanging with at least one hook as attachment means that could hang from at least one of various kinds of doors such as garage doors, exterior doors, or interior doors.

A door hanging with a hook that could hang at least one hung object from a door.

A door hanging with a hook that could permit the hung object to be put up or taken down with the hook remaining in its position on the door.

A door hanging with a hook that could be adapted to fit on doors of various thicknesses.

A door hanging with a hook that could function with a door such that, for example, the hook would not interfere with the door header when the door is opened or closed.

A door hanging with a hook that could attach mechanically to the door without being affixed directly to a surface with adhesives, magnets, etc., and without altering the surface such as by penetrating it with a tack or screw.

A door hanging with a hook that could attach mechanically to the hung object without the aid of adhesives, magnets, etc., such as by hooking into a slit or hole in the hung object.

A door hanging with a hook that could attach mechanically to a stabilizer.

A door hanging with a hook that could include different kinds of materials or combinations of materials including metals or plastics that could be made using various manufacturing techniques including molding, stamping, forming, extruding, or fabricating.

A door hanging that could attach to at least one stabilizer that could serve purposes such as serving as the object from which a hung object hangs or maintaining the shape or position of a hung object on the door, or adding weight to a hung object.

A door hanging with at least one stabilizer near the top portion of the hung object.

A door hanging with at least one stabilizer near the bottom portion of the hung object.

A door hanging with a stabilizer that could be extended or reduced in size such as a stabilizer comprising at least two shorter lengths of dowel that could be connected to form the stabilizer.

A door hanging with a hung object that could attach mechanically to a hook or stabilizer.

A door hanging with a stabilizer that could include different kinds of materials or combinations of materials including shaped materials such as metals or plastics that could be made using various manufacturing techniques including molding, stamping, forming, extruding, or fabricating; or loose materials such as sand or beads, preferably with a greater weight than the hanging material and a greater stiffness than the hanging material.

A door hanging with a hung object that could comprise many different things including flexible sheets of various shapes including rectangles, triangles, or cut-outs or three-dimensionally-shaped pieces.

A door hanging with a hung object that could be made of various materials or combinations of materials including woven or nonwoven fabrics; plastics including plastic sheeting or foam; paper or paper-like materials; and synthetic or natural materials.

A door hanging with a hung object on which images could be affixed by various methods or combinations of methods to various materials and combinations of materials including: printing, stamping, or embossing; attaching components of different sizes, shapes, and materials such as shaped fabric components or three-dimensionally-shaped latex rubber or plastic components.

Devices contemplated by this invention could be suitable for many purposes. Only some of those uses are discussed in this specification. Many other uses are contemplated within the scope of this invention.

The above summary of the present invention is not intended to describe each illustrated embodiment, object, advantage, or use of the present invention. The figures and the detailed description that follow more particularly exemplify these embodiments.

### BRIEF DESCRIPTION OF DRAWINGS

The invention may be more completely understood in consideration of the following detailed description of various embodiments of the invention in connection with the accompanying drawings, in which:

FIG. 1A is a front perspective view of a garage door banner mounted on a garage door according to a first embodiment.

FIG. 1B is a perspective view of a portion of a garage door banner showing the attachment means according to a first embodiment.

FIG. 1C is a side view of a garage door banner mounted on a closed garage door according to a first embodiment.

FIG. 1D is a side view of a garage door banner mounted on a partially open garage door according to a first embodiment.

FIG. 1E is a side view of a garage door banner mounted on a fully open garage door according to a first embodiment.

FIG. 1F is a perspective, cut-away view showing a portion of a garage door banner with a stabilizer that includes two sections of pipe according to a first embodiment.

FIG. 1G is a perspective view of a portion of a garage door banner showing a grid of holes in the garage door banner according to a first embodiment.

FIG. 2A is a perspective view of a portion of a garage door banner showing a attachment means according to a second embodiment.

FIG. 3A is a perspective view of a portion of the banner top wrapping around the top edge of a garage door and attaching with attachment means to inside of door according to a third embodiment.

FIG. 3B is a front view of the banner lying flat according to a third embodiment.

FIG. 4A is a perspective view of a portion of a door banner hanging from the door of a house according to a fourth embodiment.

FIG. 5A is a perspective view of a portion of a door banner with no stabilizer hanging from the door of a house according to a fifth embodiment.

FIG. 6A is a front perspective view of a door hanging on a garage door according to a sixth embodiment.

FIG. 6B is a perspective view of a portion of a garage door and door hanging with a hook and a stabilizer according to a sixth embodiment.

FIG. 6C is a side view of a portion of a garage door and a hook according to a sixth embodiment.

FIG. 7A is a front perspective view of a door hanging on a garage door according to a seventh embodiment.

FIG. 8A is a perspective view of a door hanging on a garage door according to an eighth embodiment.

FIG. 8B is a perspective view of a portion of a garage door and door hanging with a hook according to an eighth embodiment.

FIG. 9A is a front perspective view of a door hanging on a garage door according to a ninth embodiment.

FIG. 10A is a front perspective view of a door hanging on a garage door according to a tenth embodiment.

### DETAILED DESCRIPTION OF THE INVENTION INCLUDING A BEST MODE

Nomenclature

100 garage door banner
101 flexible sheet
102 attachment means
103 stabilizer
104 image on flexible sheet
105 grid of holes
106 top edge of garage door
107 bottom edge of garage door
108 top edge of banner
109 bottom edge of banner
110a first section of plastic pipe
110b second section of plastic pipe
111 sleeve for pipe
112 sectional garage door
113a top section of garage door
113b middle top section of garage door
113c middle bottom section of garage door
113d bottom section of garage door
114a top joint
114b middle joint
114c bottom joint
115 hinge
116 movement of banner
117 clamping force
118 interior side of door
119 exterior side of door
120 force pulling banner down in relation to bottom section
200 garage door banner
201 flexible sheet
202 attachment means
203 stabilizer
206 top edge of garage door
208 top edge of banner
212 sectional garage door
213a top section of garage door
218 interior side of door
219 exterior side of door
225 upper stabilizer
300 garage door banner
301 flexible sheet
302 attachment means
303 stabilizer
306 top edge of garage door
308 top edge of banner
309 bottom edge of banner
310a first section of plastic pipe
310b second section of plastic pipe
312 sectional garage door
313 top section of garage door
318 interior side of door
319 exterior side of door
330 contact pad
400 house door banner
401 flexible sheet
402 attachment means
403 stabilizer
406 top edge of door
407 bottom edge of door
408 top edge of banner
409 bottom edge of banner
411 sleeve for pipe
412 house door
435 frame of house door
500 house door banner
501 flexible sheet
502 attachment means
506 top edge of door
507 bottom edge of door
508 top edge of banner
509 bottom edge of banner
512 house door
535 frame of house door
600 garage door hanging
601 hung object
602a first hook
602b second hook
603a first stabilizer
603b second stabilizer
604 image on hung object
605a first opening in hung object
605b second opening in hung object
606 top edge of garage door
607 bottom edge of garage door
608 top edge of hung object
609 bottom edge of hung object
611a sleeve for first stabilizer
611b sleeve for second stabilizer
612 sectional garage door
613a top section of garage door
613b middle top section of garage door
613c middle bottom section of garage door
613d bottom section of garage door
617 clamping force
618 interior side of door
619 exterior side of door
650 garage door header
651 weather-stripping
652 profile of hook
700 garage door hanging
701 hung object
702a first hook
702b second hook
703 stabilizer
704 image on hung object
705a first opening in hung object
705b second opening in hung object
706 top edge of garage door
707 bottom edge of garage door
708 top edge of hung object
709 bottom edge of hung object
711 sleeve for stabilizer
712 sectional garage door
800 garage door hanging
801 hung object
802a first hook
802b second hook
803 stabilizer
804 image on hung object
805a first opening in hung object
805b second opening in hung object
806 top edge of garage door
807 bottom edge of garage door
808 top edge of hung object
809 bottom edge of hung object
811 sleeve for stabilizer
812 sectional garage door
840a first grommet
840b second grommet
900 garage door hanging
901 hung object
902 hook
904 image on hung object
906 top edge of garage door
907 bottom edge of garage door
908 top edge of hung object
909 bottom edge of hung object
912 sectional garage door
945a first component
945b second component
945c third component
946 connectors
1000 garage door hanging
1001 hung object
1002a first hook
1002b second hook
1003 stabilizer
1004 image on hung object
1005a first opening in hung object
1005b second opening in hung object
1006 top edge of garage door
1007 bottom edge of garage door
1008 top edge of hung object
1009 bottom edge of hung object
1011 sleeve for stabilizer
1012 sectional garage door
   Terminology

Where this specification uses terms to describe garage doors, the intent is to be consistent with the definitions set out in “Technical Data Sheet #160,” from the Door and Access Manufacturers Association International (DASMA) of Aug. 8, 2001.

Construction

### First Embodiment

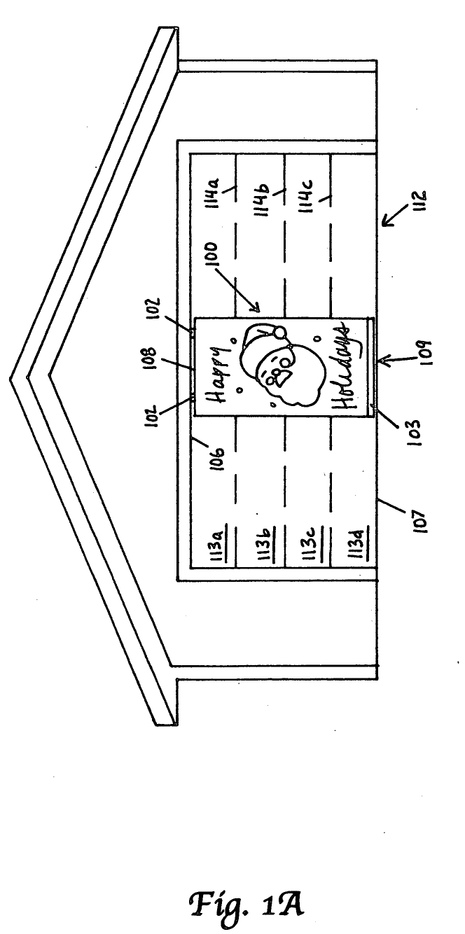

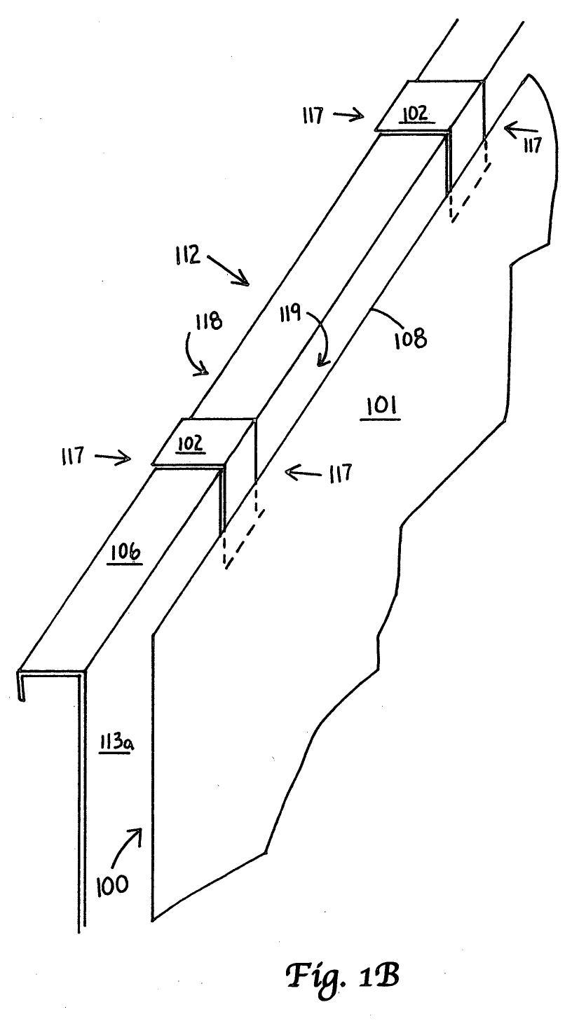

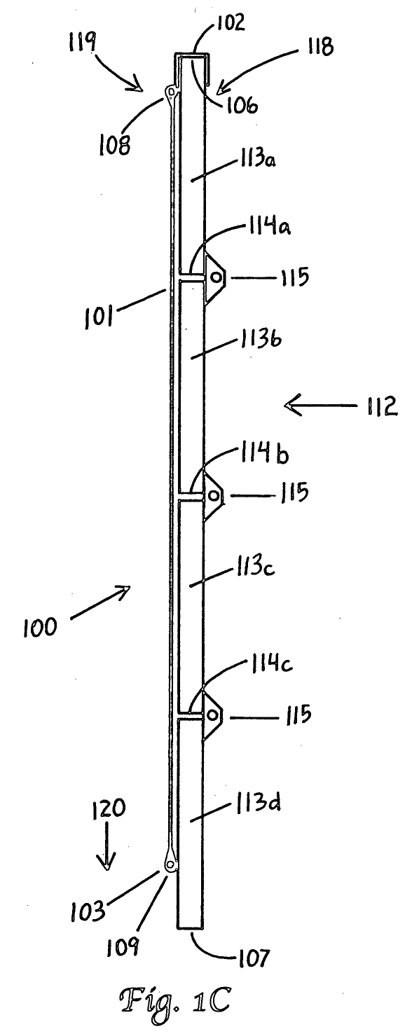

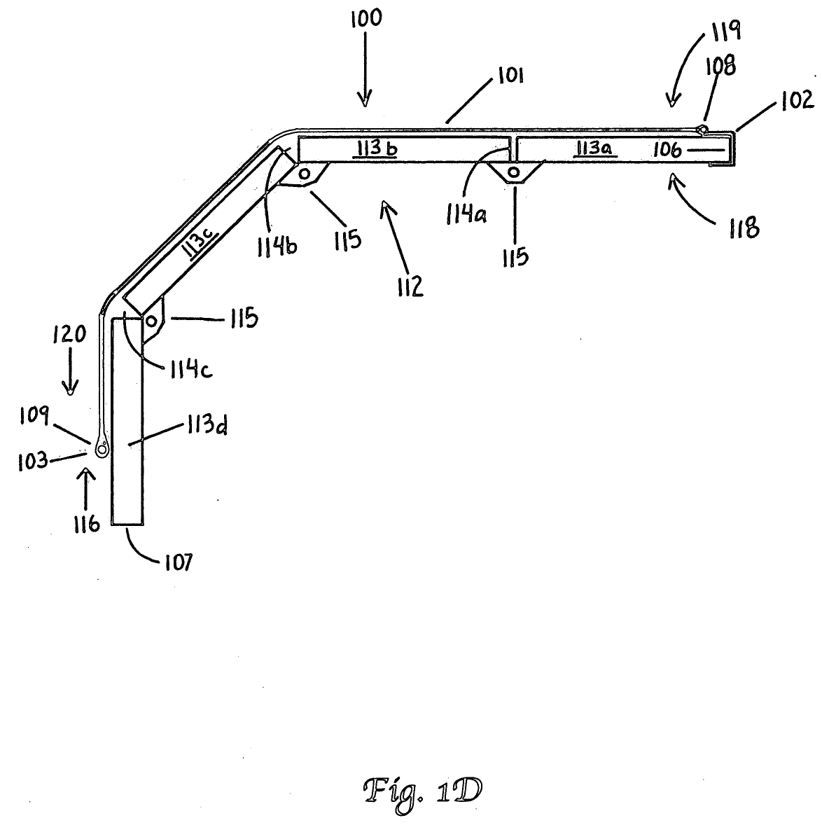

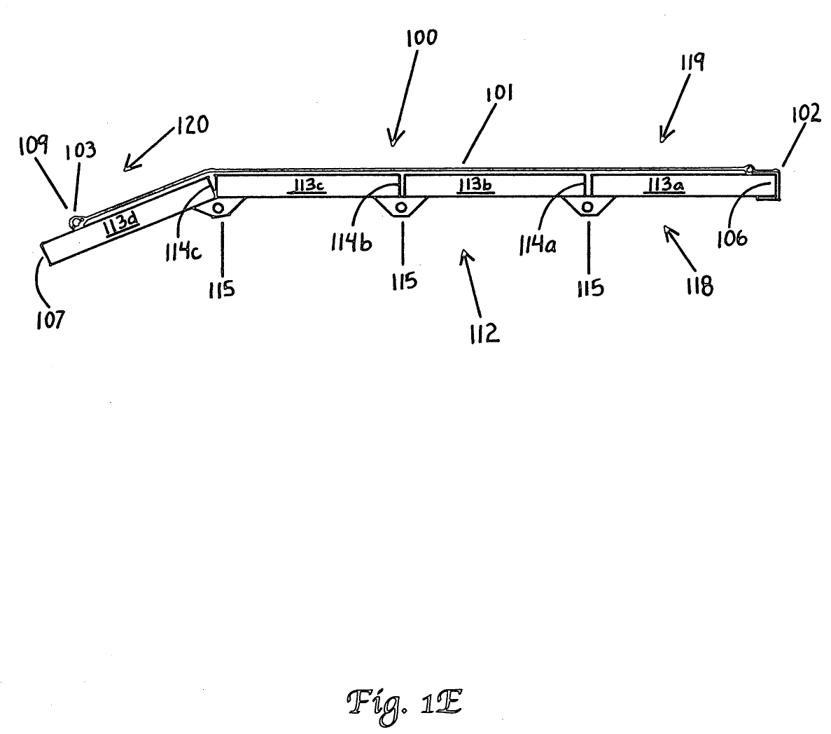

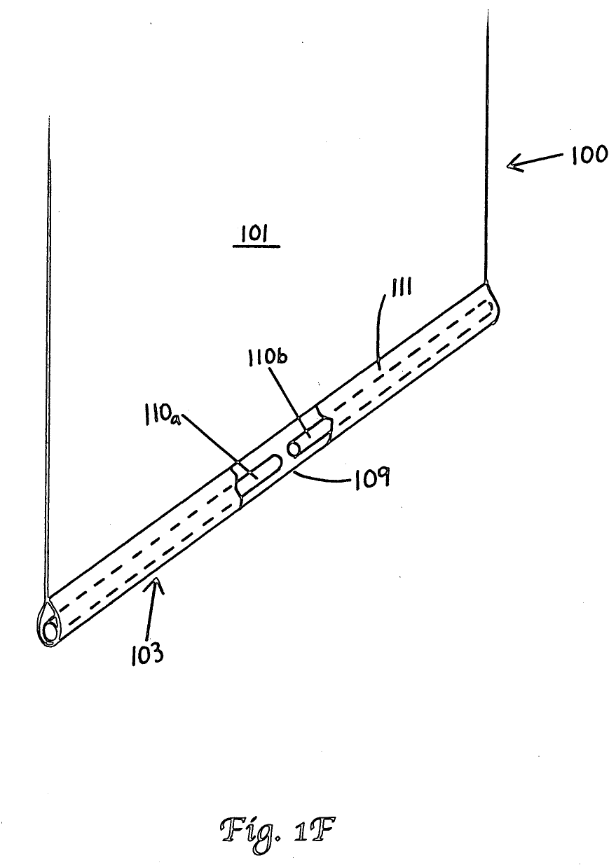

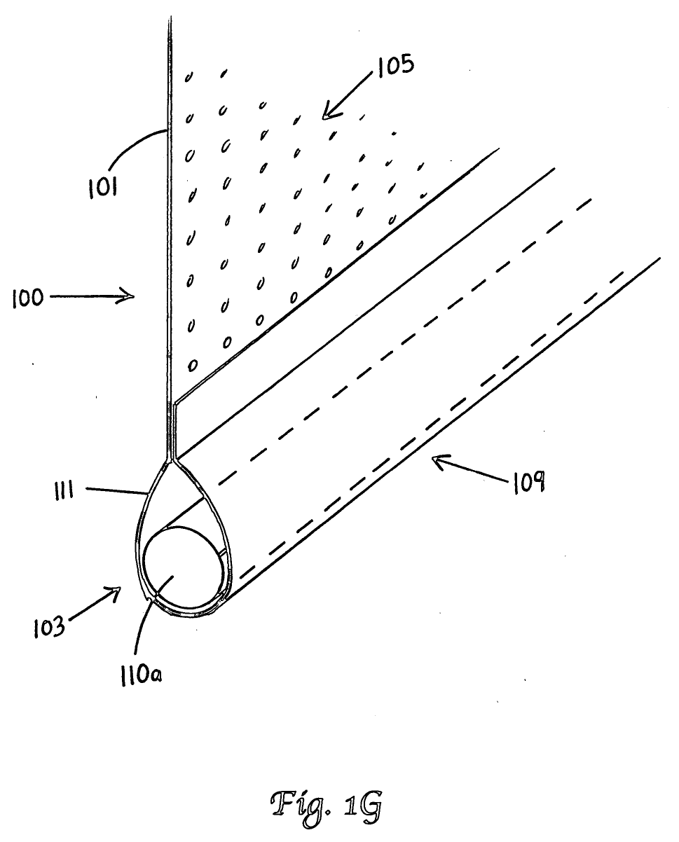

FIGS. 1A to 1G show a garage door banner 100 according to a first embodiment of the invention. The garage door banner 100 could consist of a flexible sheet 101, attachment means 102, and a stabilizer 103.

The flexible sheet 101 shown in FIGS. 1A to 1D could be made of a lightweight fabric. The images 104 could be printed on the flexible sheet 101. As shown in FIG. 1G, the flexible sheet 101 could have a grid of holes 105 through the sheet 101. Such a grid 105 could reduce billowing of the flexible sheet 101 in the wind. Such a grid 105 could easily be created using a mesh fabric or a nonwoven fabric with perforations. In addition, if the flexible sheet 101 were made of plastic, the grid 105 could be created relatively easily with a punching or other fabrication process.

The attachment means 102 could have a C-shape and could fit over the top edge 106 of the garage door 112. FIG. 1B shows two C-shaped attachment means 102. The attachment means 102 could be permanently affixed to the top edge 108 of the banner 100. The attachment means 102 could be made of a springy material to create a clamping force 117 on the interior and exterior surfaces 118, 119 of the door 100 just below the top edge 106. Alternatively, the attachment means 102 could simply hook over the top edge 106, relying primarily on gravity and the weight of the flexible sheet 101 and the stabilizer 103 to keep the banner 100 in position.

The stabilizer 103 shown in FIG. 1F could simply be two sections of plastic pipe 110a, 110b that fit in a sleeve 111 along the bottom edge 109 of the banner 100. The stabilizer 103 could preferably be of a heavier material than the flexible sheet 101. The sleeve 111 that encloses the sections of pipe 110a, 110b could protect the exterior surface 119 of the garage door 112.

The stabilizer 103 could serve at least two functions. First it could help maintain the shape of the banner 100, preventing puckering or gathering of the flexible sheet 101. Second, it could add weight to the bottom edge 109 of the banner 100 to help keep the banner 100 hanging tautly from the top edge 106 of the door 100.

The two sections of pipe 110a, 110b shown in FIG. 1F have the advantage of being more easily stored than a single longer stabilizer (not shown). For shipping, retail display, and storage, the two sections 110a, 110b could be stored in a shorter container than a single longer stabilizer (not shown).

When used on a typical sectional garage door 112 in a closed position, the banner 100 could hang freely from the top edge 106 of the garage door 112 as shown in FIG. 1C. When the garage door 112 opens as shown in FIG. 1D, the banner 100 moves in relation to the exterior surface 119 because the joints 114a to 114c between the sections 113a-113d of the garage door 100 open. Thus, when the garage door 100 opens as shown in FIG. 1D, the bottom edge 109 of the banner 100 moves 116 in relation to the bottom section 113d. Because the banner 100 hangs freely from the attachment means 102 on the top edge 106 of the garage door 112, the banner 100 could accommodate this movement 116. The weight of the stabilizer 103 and the banner 100 could combine to ensure the banner 100 still remains securely attached by the attachment means 102.

FIG. 1E shows the banner 100 resting on the garage door 112 in the fully open position. Even in this position, the attachment means 102 should not come loose from the garage door 112 because the weight of the stabilizer 103 pulling down 120 the incline of the bottom section 1113d should hold the banner 100 taut on the exterior surface 119 of the door 100.

### Second Embodiment

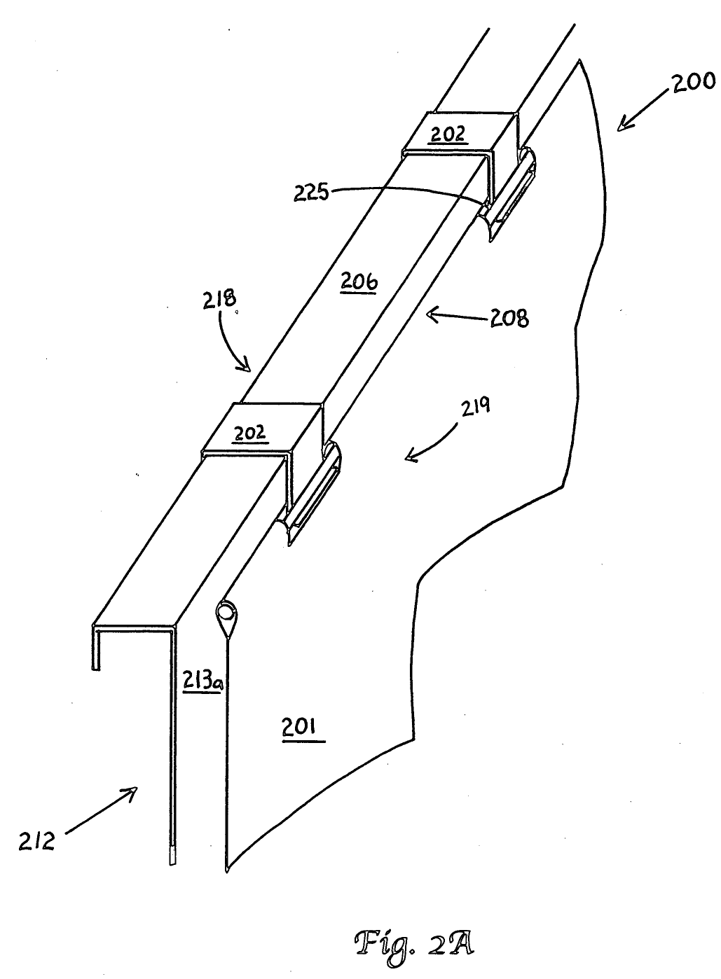

FIGS. 2A and 2B show a door banner 200 according to the second embodiment. The banner 200 could substantially resemble the banner 100 shown in relation to FIGS. 1A to 1G with one primary difference. The attachment means 202 for banner 200 could be integrated into an upper stabilizer. The upper stabilizer 225 could help maintain the shape of the banner 200 and could complement a lower stabilizer (not shown) on the bottom edge (not shown) of the banner 200.

### Third Embodiment

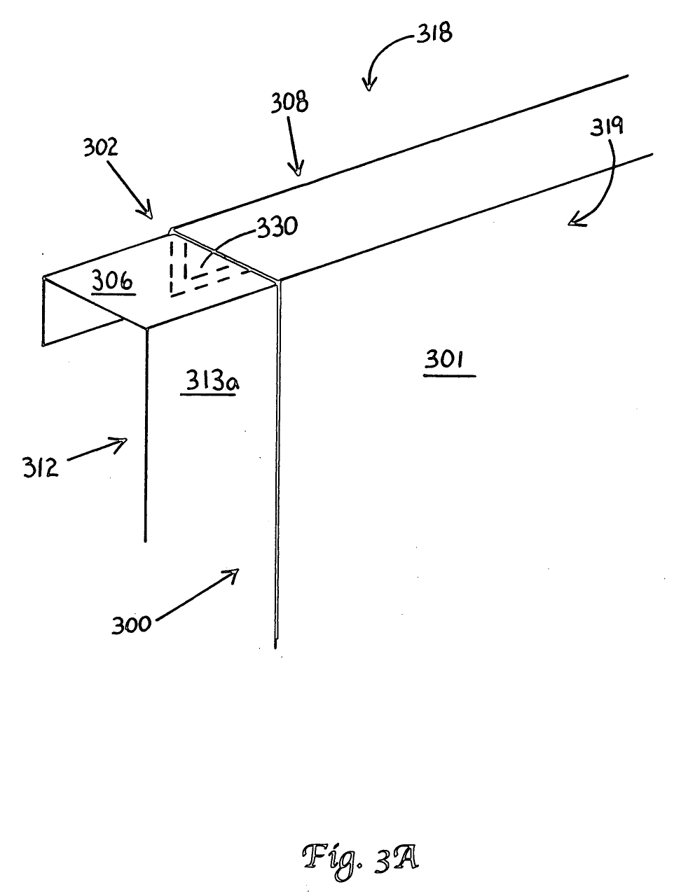

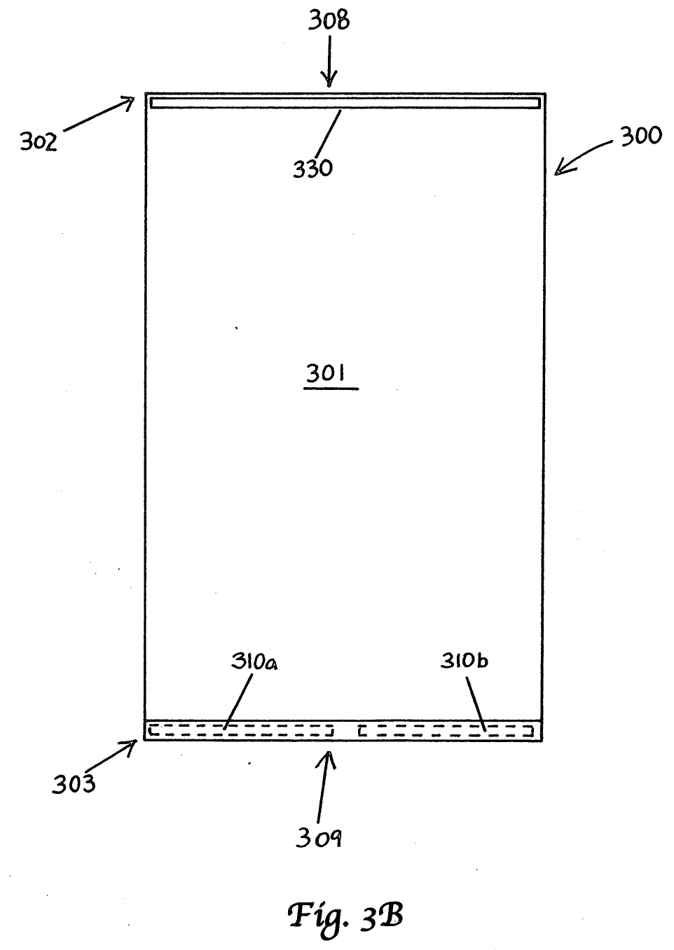

FIGS. 3A and 3B show a garage door banner 300 according to the third embodiment. The banner 300 could substantially resemble the banner 100 shown in relation to FIGS. 1A to 1G with the primary difference being the attachment means 302 for banner 300. The attachment means for banner 300 could consist of a contact pad 330 that attaches to the interior side 318 of the top section of the garage door. The contact pad 330 could use magnets or adhesive to attach to the interior surface 318 of the door. A magnetic contact pad 330 could work on a metallic garage door 312. The flexible sheet 301 could simply drape over the top edge 306 of the garage door 312 as shown in FIG. 3A.

### Fourth Embodiment

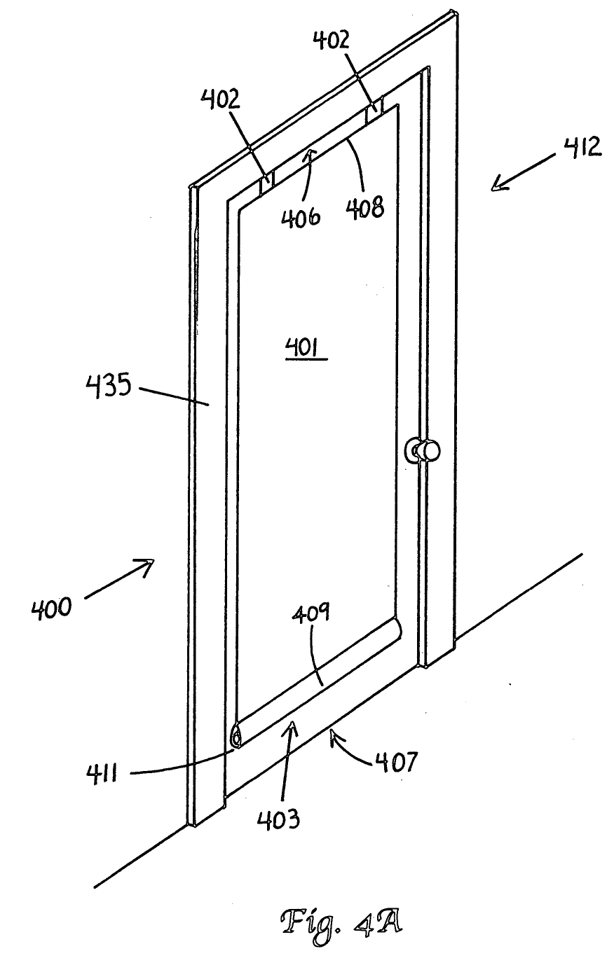

FIG. 4A shows a door banner 400 according to the fourth embodiment. The banner 400 shown in FIG. 4A hangs from a typical house door 412. The banner 400 shown in FIG. 4A could substantially resemble the banner 100 shown in relation to FIGS. 1A to 1G except the size of the banner 400 would likely be different.

### Fifth Embodiment

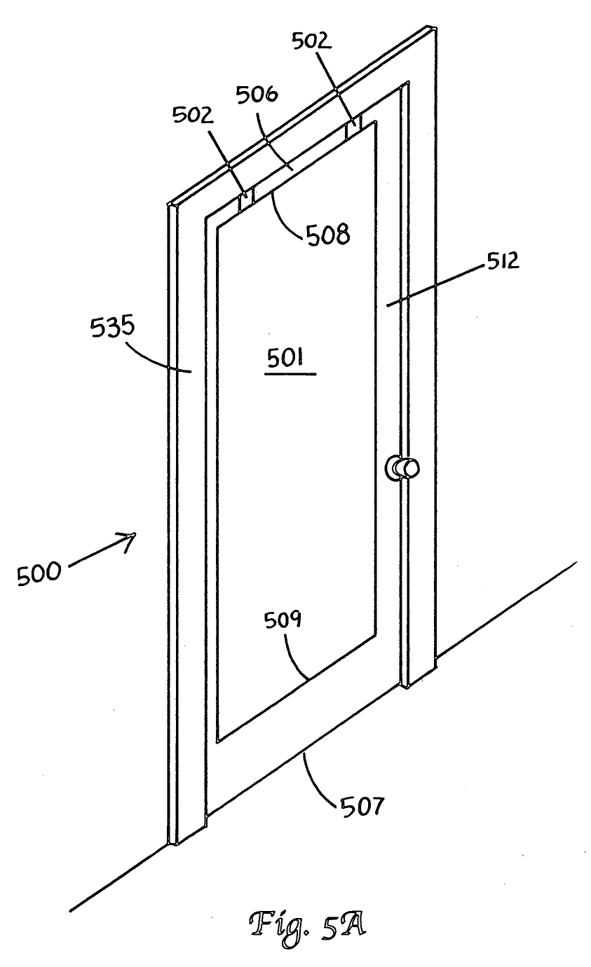

FIG. 5A shows a door banner 500 according to the fifth embodiment. The banner 500 shown in FIG. 5A hangs from a typical house door 512. The banner 500 shown in FIG. 5A could substantially resemble the banner 400 shown in relation to FIG. 4A with at least one primary difference. The banner 500 as shown in FIG. 5A has no stabilizer. Such a banner 500 could be appropriate where, for example, the flexible sheet 501 is made of sufficiently heavy material or if the door 512 were inside a home (not shown).

### Sixth Embodiment

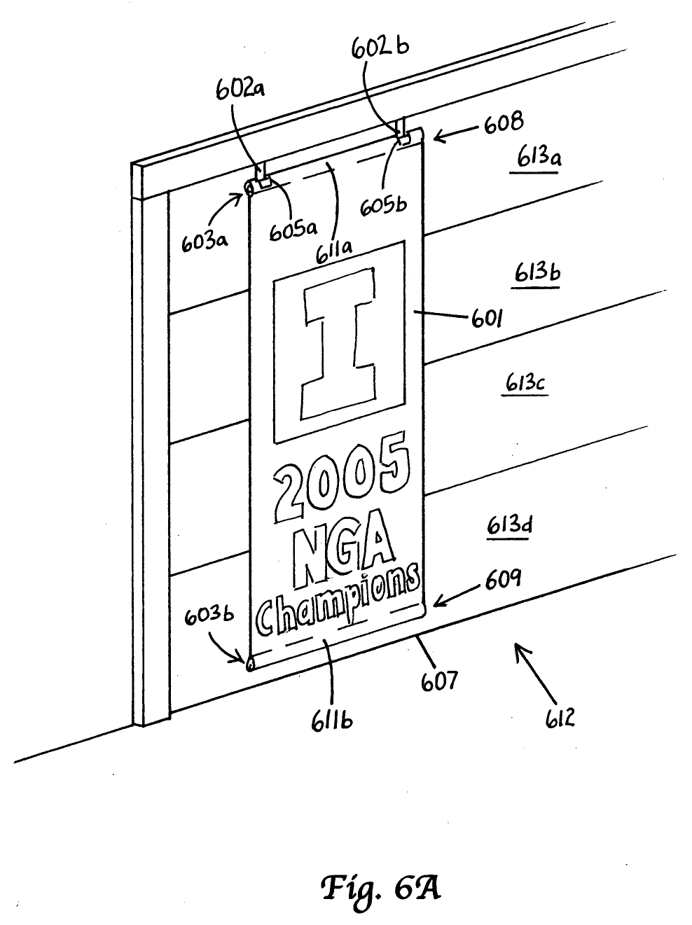

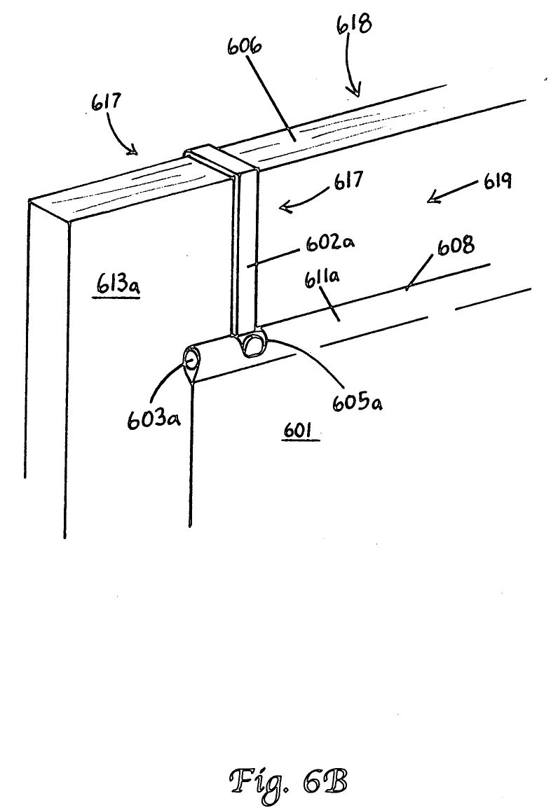

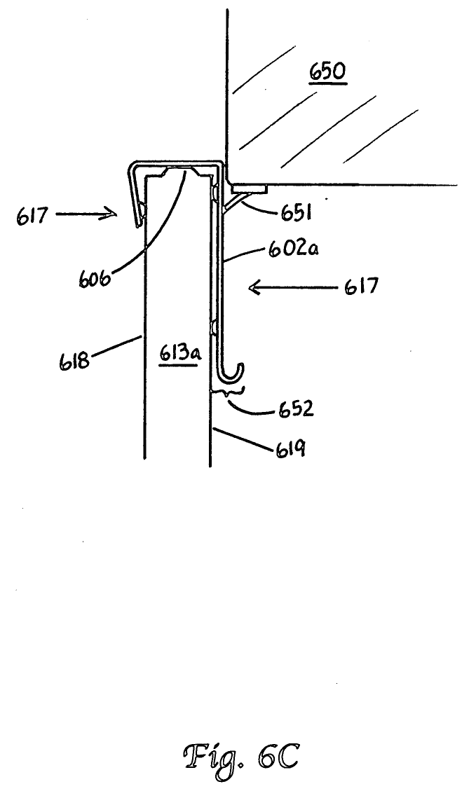

FIGS. 6A to 6C show a garage door hanging 600 according to a sixth embodiment of the invention. The garage door hanging 600 could consist of a hung object 601, hooks 602a and 602b, and stabilizers 603a and 603b. The hung object 601 could display an image 604. When used on a typical sectional garage door 612 in a closed position, the hanging 601 could hang freely from the top edge 606 of the garage door 612 as shown in FIG. 6A.

The hung object 601 shown in FIGS. 6A to 6C could be made of a fabric of different weights. Because the door hanging 600 has two stabilizers, 603a and 603b, the fabric could be relatively lightweight.

The hung object could have sleeves 611a and 611b into which the stabilizers 603a and 603b could be inserted.

The hooks 602a and 602b could fit over and mechanically attach to the top edge 606 of the garage door 612. FIGS. 6B and 6C show different views of the hooks, 602a and 602b. The hooks 602a and 602b. The hooks 602a and 602b could slide through openings 605a and 605b in the hung object 601. The first stabilizer 603a could rest on the hooks 602a and 602b as shown in FIGS. 6A and 6B. This could make it easy to hang the hung object 601 or to take down the hung object 601.

The hooks 602a and 602b could be made of a springy material to create a clamping force 617 on the interior and exterior surfaces 618, 619 of the door 612 just below the top edge 606. Alternatively, the hooks 602a and 602b could simply hook over the top edge 606, relying primarily on gravity and the weight of the hung object 601 and the stabilizers 603a and 603b to keep the hanging 600 in position.

FIG. 6A shows two hooks 602a and 602b for hanging the hung object 601. However, more hooks or other attachment means could be used to hang, for example, a larger hung object (not shown).

The hooks 602a and 602b should have a sufficiently low profile 652 extending from the exterior side 619 of the garage door 612. This could prevent the hooks 602a and 602b from snagging (not shown) on weather-stripping 651 or the garage door header 650 when the garage door 612 is opened (not shown).

Having two stabilizers 603a and 603b could serve at least two functions. First it could help maintain the shape of the hung object 601, preventing puckering or gathering of the hung object 601 near the top edge 608 or bottom edge 609 of the hung object 601. Second, it could add weight to the hanging 600 to maintain the position of the hanging 600 on the door 612. the bottom edge 609 of the hanging 600 to help keep the hanging 600 hanging tautly from the top edge 606 of the door 600.

### Seventh Embodiment

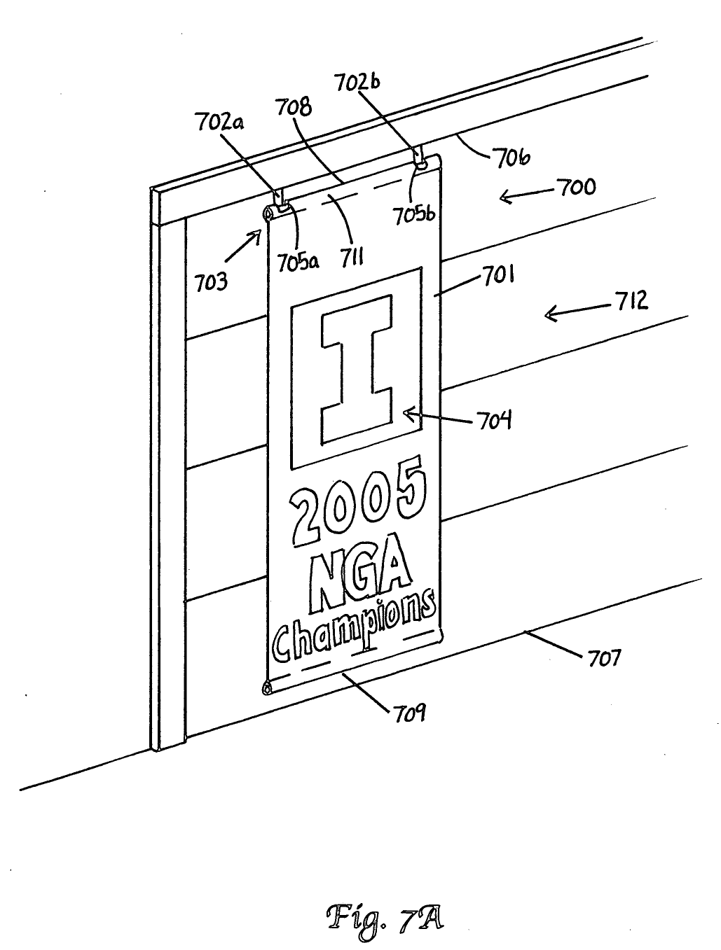

FIG. 7A shows a door hanging 700 according to the seventh embodiment. The hanging 700 could substantially resemble the hanging 600 shown in relation to FIGS. 6A to 6C with one primary difference. The bottom edge 709 of the hung object 701 has no stabilizer.

A hanging 700 with only a top stabilizer 703 might be suitable, for example, for a hung object 701 made of heavier fabric or other materials than the hung object 101 shown in FIGS. 1A to 1C.

### Eighth Embodiment

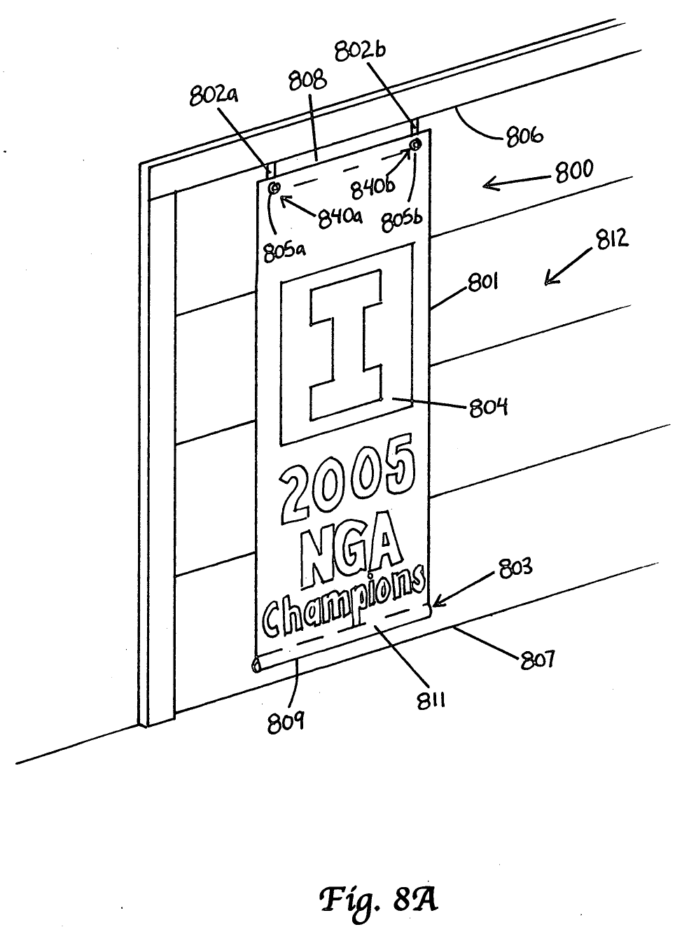

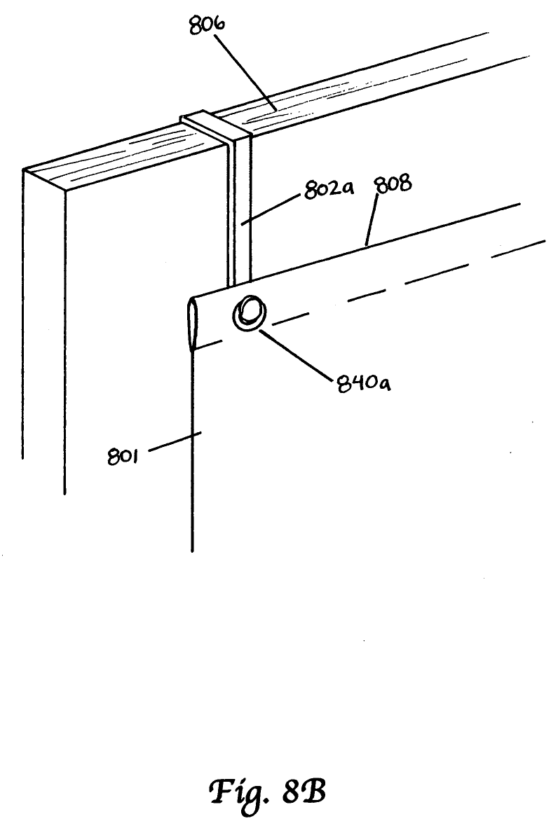

FIGS. 8A and 8B show a door hanging 800 according to the eighth embodiment. The hanging 800 could substantially resemble the hanging 600 shown in relation to FIGS. 6A to 6C with one primary difference. The top edge 808 of the hung object 801 has no stabilizer. Instead the hooks 802a and 802b could fit in openings 805a and 805b in the hung object 801. The openings could be reinforced with grommets 840a and 840b.

### Ninth Embodiment

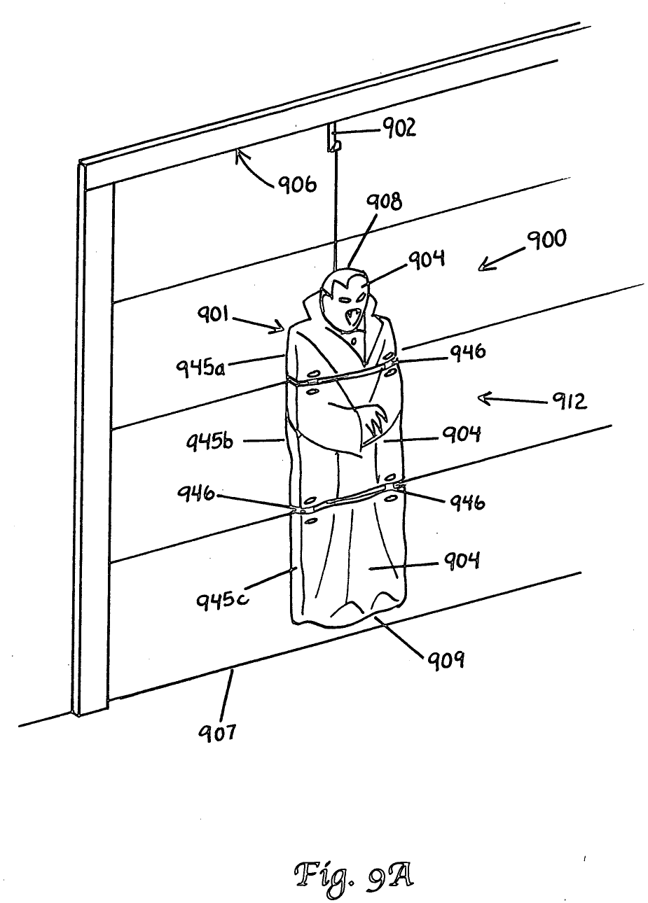

FIG. 9A shows a door hanging 900 according to the ninth embodiment. The hanging 400 could substantially resemble the hanging 600 shown in relation to FIGS. 6A to 6C with two major differences. First, the hanging 900 shown in FIG. 9A only utilizes one hook 902. Second, the hung object consists of three components, 945a, 945b, and 945c. The hung object 901 could be hung from the hook with a string 946. The three components, 945a to 945c could be connected to each other with connectors 946 such as straps. The connectors 946 could permit the hung object 901 to flex to accommodate the opening and closing of the garage door 912 (not shown).

As shown in FIG. 9A, the hung object 901 could have components 945a to 945c with images 904 that have surface relief to better depict the image 904 on the hung object 901. Such surface relief could be created using processes such as vacuum forming. Other processes could be used as well.

### Tenth Embodiment

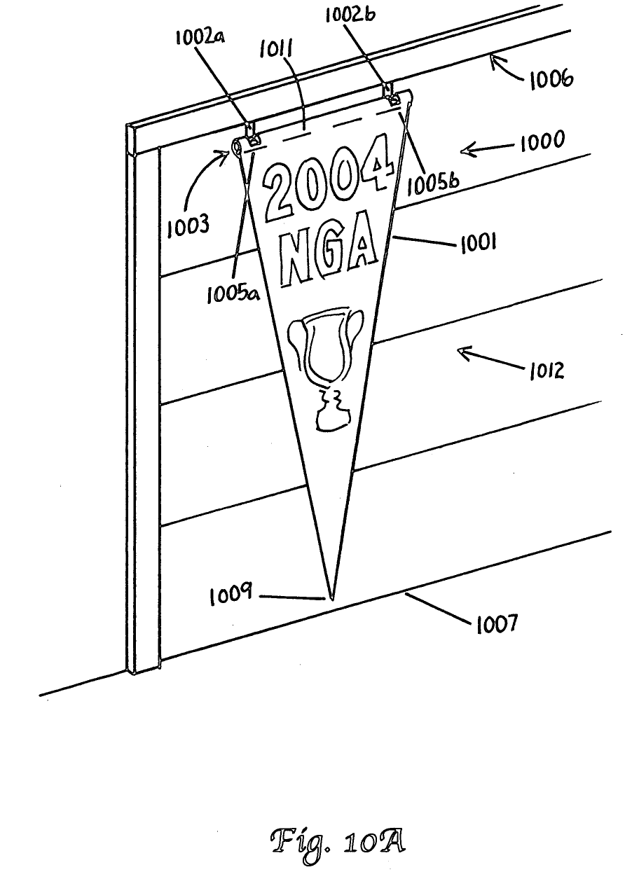

FIG. 10A shows a door hanging 1000 according to the tenth embodiment. The hung object 1001 resembles the shape of a large pennant of the kind associated with sports merchandise. Because the pennant comes to a point at the bottom edge 1009, no bottom stabilizer may be necessary.

Modifications

The present invention should not be considered limited to the particular examples described above, but rather should be understood to cover all aspects of the invention as fairly set out in the claims arising from this application. For example, while suitable sizes, materials, fasteners, and the like have been disclosed in the above discussion, it should be appreciated that these are provided by way of example and not of limitation as a number of other sizes, materials, fasteners, and so forth may be used without departing from the invention. Various modifications as well as numerous structures to which the present invention may be applicable will be readily apparent to those of skill in the art to which the present invention is directed upon review of the present specifications. The claims which arise from this application are intended to cover such modifications and structures.

We claim:

1. A door hanging assembly comprising:
a. a sectional garage door, having at least top and bottom sections, which sections have top and bottom edges, and which sections rotate relative to each other when the garage door opens and closes;
b. a hung object with a top end and a bottom end; and
c. at least one hook configured and arranged for hanging the top end of the hung object on the top edge of the top section;
d. wherein the length and weight of the hung object are sufficient to maintain the bottom end of the hung object between the top edge and the bottom edge of one section when the garage door opens and closes.

2. A door hanging assembly comprising:
a. a sectional garage door, having at least top and bottom sections, which sections have top and bottom edges, and which sections rotate relative to each other when the garage door opens and closes;
b. a hung object with a top end and a bottom end;
c. at least one hook configured and arranged for hanging the top end of the hung object on the top edge of the top section; and
d. at least one stabilizer affixed to the bottom end of the hung object;
e. wherein the length of the hung object and the weight of the hung object and of the stabilizer are sufficient to maintain the bottom end of the hung object between the top edge and the bottom edge of one section when the garage door opens and closes.

3. A garage door hanging assembly comprising:
a. a sectional garage door, having at least top and bottom sections, which sections have top and bottom edges, and which sections rotate relative to each other when the garage door opens and closes;
b. a hung object comprising at least top and bottom pieces hingedly connected to each other; and
c. at least one hook configured and arranged for hanging the top piece on the top edge of the top section;
d. wherein the hingedly connected pieces rotate in cooperation with the rotating sections when the garage door opens and closes.

4. The door hanging assembly of claim 1 further comprising at least two hooks.

5. The door hanging assembly of claim 1 further comprising at least one hook that projects from an exterior surface of the top section a distance such as to prevent contact with the garage door header and any header weather-stripping when the garage door opens and closes.

6. The door hanging assembly of claim 1 wherein at least one hook clamps onto the top edge of the top section.

7. The door hanging assembly of claim 1 wherein a stabilizer is weighted to make the stabilizer substantially of a heavier material than the hung object.

8. The door hanging assembly of claim 1 wherein a stabilizer is a horizontally oriented rod.

9. The door hanging assembly of claim 1 wherein a stabilizer comprises at least two sections of horizontally oriented rod.

10. The door hanging assembly of claim 1 wherein a horizontally oriented stabilizer rod is at the top end of the hung object.

11. The door hanging assembly of claim 1 wherein a horizontally oriented stabilizer rod at the top end of the hung object connects to at least one hook.

12. The door hanging assembly of claim 1 wherein a stabilizer is at the top end and bottom end of the hung object.

13. The door hanging apparatus of claim 1 wherein the hung object is one of the following shapes: rectangular, triangular, circular, and trapezoidal.

14. The door hanging apparatus of claim 1 wherein the hung object is pennant-shaped with its tip oriented toward the bottom section and the tip has a weighted stabilizer affixed to it.

15. The door hanging assembly of claim 3 further comprising at least three hingedly connected pieces.

16. The door hanging assembly of claim 3 further comprising at least four hingedly connected pieces.

17. The door hanging assembly of claim 3 further comprising at least two hooks.

18. The door hanging assembly of claim 3 wherein at least portions of the pieces have surface relief.
